(19) United States
(12) Patent Application Publication
(10) Pub. No.: US 2005/0271452 A1
(43) Pub. Date: Dec. 8, 2005

(54) Ultraviolet invisible ink dry erase board

(76) Inventors: Sun Yu, Berkley, MI (US); David Perrin, Troy, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/197,418

(22) Filed: Aug. 4, 2005

Related U.S. Application Data
(63) Continuation-in-part of application No. 10/929,971, filed on Aug. 30, 2004.
Application No. 10/929,971 is a continuation of application No. 10/264,993, filed on Oct. 4, 2002, now Pat. No. 6,860,616.
(60) Provisional application No. 60/341,434, filed on Dec. 14, 2001.

(51) Int. Cl. B41M 5/00

(52) U.S. Cl. 401/123

(57) ABSTRACT

A dry erase article includes a transparent or translucent polymeric writing layer having a top surface that is impenetrable to an ink. A substrate independent of visible fluorescent constituent is provided that obscures UV ink marks underlying the writing layer allows for both visible light and ultraviolet light inks to be visualized on the top surface of the writing layer. A writing system includes such a dry erase article, an ultraviolet ink containing writing implement and an ultraviolet light source. A dry erase article optionally includes substrate particulate suspended in an otherwise transparent or translucent layer. Alternatively, a precursor to the transparent or translucent layer is applied and then cures or dries to yield such a layer.

### RELATED APPLICATIONS

This application is a continuation-in-part of U.S. patent application Ser. No. 10/929,971 filed Aug. 30, 2004, which is a continuation of U.S. patent application Ser. No. 10/264,993 filed Oct. 4, 2002, which claims priority of U.S. Provisional Application No. 60/341,434 filed Dec. 14, 2001.

### FIELD OF THE INVENTION

The present invention in general relates to a dry erase board and in particular to a dry erase board on which ultraviolet inks are visualized.

### BACKGROUND OF THE INVENTION

Dry erase boards are characterized by a polymeric sheet adhered to a substrate to receive visible inks that are amenable to removal by blotting or wiping absent solvent. In order to obtain maximal contrast between the applied ink and the substrate, the substrate is a white-colored material. The substrate and ink-receiving coating are often polymerization cured together so as to preclude blistering, delamination and ink penetration to the substrate caused by a compromised coating layer.

Ultraviolet inks are virtually invisible under natural and room ambient light conditions; yet upon excitation by ultraviolet light, ultraviolet inks and phosphors fluoresce or phosphoresce in the visible portion of the light spectrum. This visualization of ultraviolet inks is masked to a great extent by applying a UV active ink to a surface containing ultraviolet active bleaching agents and/or brighteners. As a result, ultraviolet ink markings on a conventional dry erase board are poorly visualized under ultraviolet light exposure.

Thus, there exists a need for a dry erase board on which ultraviolet inks are readily visualized.

### SUMMARY OF THE INVENTION

A dry erase article includes a transparent or translucent polymeric writing layer having a top surface that is impenetrable to an ink. A substrate independent of visible fluorescent constituent that obscures UV ink marks is provided underlying the writing layer and allows for both visible light and ultraviolet light inks to be visualized on the top surface of the writing layer. A writing system includes such a dry erase article, an ultraviolet ink containing writing implement and an ultraviolet light source.

A dry erase article optionally includes substrate particulate suspended in an otherwise transparent or translucent layer. Alternatively, a precursor to the transparent or translucent layer is applied and then cures or dries to yield such a layer.

### BRIEF DESCRIPTION OF THE DRAWINGS

FIG. 1 is a partial cutaway view of an inventive dry erase board; and

FIG. 2 is a cross-sectional view of an inventive monolayer dry erase board, where the relative dimensions of components are modified for illustrative purposes.

### DETAILED DESCRIPTION OF THE PREFERRED EMBODIMENTS

The present invention has utility as a dry erase board on which both visible ink and invisible ink indicia are visualized under appropriate lighting conditions. The present invention affords several benefits as compared to a conventional dry erase board in regard to enhanced security, increased effective writing area, and enhanced presentation effects.

An inventive dry erase article includes a transparent or translucent polymeric writing layer that is impenetrable to an ink put on the surface thereof such that the ink can be removed from the top surface with the use of a dry cloth or paper tissue. A substrate layer is bonded to the writing layer or substrate particulate embedded within the writing layer operative herein is defined to be “substantially free of visible light fluorophores” when a substrate provides reflection of incident visible and ultraviolet without visible fluorescence to a level that obscures the visible fluorescence associated with an ultraviolet (UV) active ink, and preferably is devoid of optical brighteners and allows for both visible and ultraviolet active inks to be visualized on the inventive dry erase article. A UV security pen is exemplary of a conventional writing implement operative herein as a UV ink source.

It has been surprisingly discovered that colorants associated with dying a writing substrate are particularly well suited to modify the appearance and fluorescence lifetime of the security pen dye, as compared to the same security pen dye applied to whitened substrate. However, it is appreciated that substrates absent optical brighteners or otherwise strongly fluorescent in the visible portion of the light spectrum are also operative herein as a substrate layer or embedding particulate. Without intending to be limited to a particular theory, these substrates are believed to include a dye that upon UV illumination fluoresces in the same wavelength range as many UV security inks thereby obscuring the security pen markings. The changes in security dye fluorescence characteristics on an inventive substrate can render such writings at least partially obscured upon illumination with other conventional broad wavelength range light sources used to image security dye. Specifically, security dye markings rendered on a colored writing substrate are significantly obscured when viewed with a black light. As a result, a user of an inventive article is afforded an added degree of security relative to unintended examination with the most common security dye imaging light source. This property of an inventive commercial package is particularly well suited for incorporation into a diary, personal journal, or private communication board.

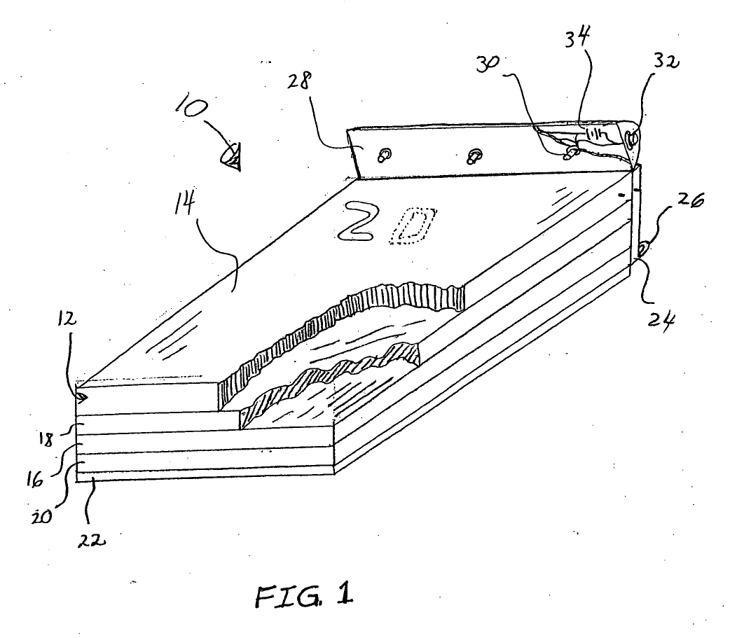

Referring now to FIG. 1, an inventive dry erase article is shown generally at 10. Dry erase article 10 has a transparent or translucent polymeric writing layer 12, the writing layer 12 defining an ink-receiving top surface 14. The polymeric writing layer 12 has sufficient transmissivity of light from the top surface 14 through to the underlying substrate 16 underlying the writing layer 12. Preferably, the polymeric writing layer 12 is transparent. A wide variety of polymeric coatings are operative herein as a writing layer 12. The requirements for a polymeric coating material are that an ink applied thereto does not penetrate beyond the surface 14 and thereby preclude dry erasure with a cloth or paper tissue. Suitable polymeric coating materials operative herein illustratively include polyalkylenes such as polyethylene and polypropylene; acrylates such as epoxy acrylates, urethane acrylate; latexes; epoxies; polystyrenes, polyvinyl toluene, polyethylene ether polymers, polyphenyl oxide polymers and combinations thereof. Copolymers operative as writing layers include the above-recited polymers in addition to copolymers of the same including butadiene, acrylonitrile and vinyl chloride. It is appreciated that an inventive writing layer is formed through free radical, addition or radiation polymerization from precursor monomers and/or oligomers or alternatively applied as a preformed sheet secured to the substrate 16. The writing layer 12 typically has a thickness in the range of 0.1 to 50 mils. Optionally, a contact adhesive 18 is applied intermediate between the writing layer 12 and the substrate 16 in order to facilitate bonding therebetween. Such adhesives are well known to the art and used in association with graphic constructs and illustratively include polyurethanes, polycyanoacrylates, epoxies, and latexes. The colored and preferably pastel or neon substrate 16 is in the form of paper, a synthetic polymeric sheet, or a paint on a base structure. The substrate 16 has the properties of being flexible or rigid, as well as opaque or non-opaque. In one embodiment of an inventive dry erase article, the substrate 16 is transparent or translucent. Polymethyl methacrylate represents a preferred material from which to form a transparent substrate 16.

Optionally, a backing adhesive layer 20 is secured to the rearward surface of the substrate 16 in order to facilitate repositionable or permanent adherence of an inventive article 10 to a wall, board or other placement. It is appreciated that a repositionable adhesive is selected in those instances where one desires an impermanent positioning. Repositionable adhesives illustratively include acrylic copolymers in an aqueous solution with a defoamer as sold by 3M Corporation under the trade name Post-it®. Conventional permanent adhesion adhesives for the adhesive backing 20 are those detailed with respect to adhesive 18. In those instances where a backing adhesive 20 is present, preferably a protective release sheet 22 is provided to protect the underlying backing adhesive 20 during storage and handling prior to placement. Such backing sheets 22 are known to the art and include a paper or other substrate coated with a release coating such as a fluoropolymer or a silicone.

It is appreciated that either alone or in combination with a backing adhesive 20, a mechanical securement fitting 24 is provided to facilitate mounting of an inventive article 10 with mechanical fasteners. The securement 24 typically includes an eyelet 26 designed to engage a mechanical fastener and from which the inventive article 10 can be suspended.

The top surface 14 is intended to receive an ink visualized under visible light sources such as sunlight, incandescent light and fluorescent lighting fixtures. A visual ink marking is denoted in FIG. 1 as “Z”. Visible ink markings are provided from a variety of marking instruments illustratively including a grease pencil and a pen. Ink visualized under ultraviolet light becomes visible upon illumination with wavelengths of less than 420 nanometers. A UV ink upon radiation from a suitable light source fluoresces or phosphoresces in the visible portion of the light spectrum. A writing instrument having ink visualized under exposure to ultraviolet light is commercially available from Sanford and sold as a security marker.

An ultraviolet light source operative with an inventive article has a principal emission wavelength of between 370 and 420 nanometers. Preferably, the ultraviolet light source is a UV LED or UV cold cathode fluorescent lamp (CCFL), although it is appreciated that black light and other ultraviolet-emitting light sources are nominally operative herein. Optionally, the ultraviolet LED or CCFL light source is integrated into the inventive article 10 with an orientation to expose the top surface 14 of the writing layer 12 to ultraviolet light emissions. A housing 28 proximal to the surface 14 incorporates at least one ultraviolet emitting LED or CCFL 30. A switch 32 is provided to selectively complete an electrical circuit between the LED or CCFL 30 and a power source shown schematically in FIG. 1 to be a battery 34. Line power is also appreciated to represent a suitable power source upon transforming. Upon the LED or CCFL 30 being energized, ultraviolet ink indicia on the top surface 14 are exposed to ultraviolet radiation so as to render the markings visible. An ultraviolet ink marking is denoted in FIG. 1 as “D”.

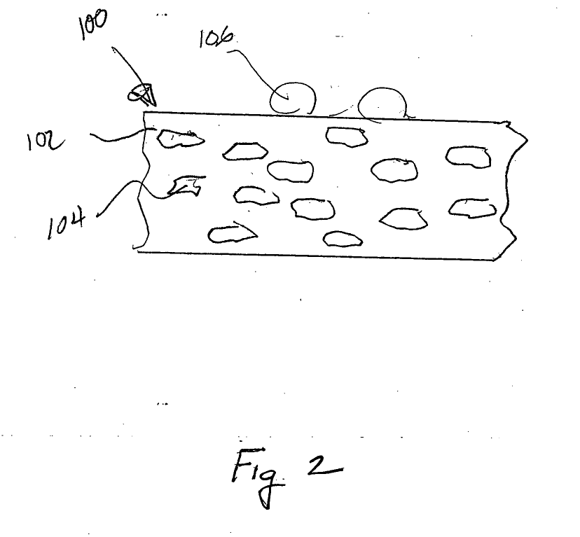

Referring now to FIG. 2, an inventive dry erase film is shown generally at 100. A dry erase film includes a polymer precursor that upon cure forms a polymeric writing layer 102. A suitable polymer writing layer is formed of a polymer illustratively including polyalkylenes such as polyethylene and polypropylene; acrylates such as epoxy acrylates, urethane acrylate; latexes; epoxies; polystyrenes, polyvinyl toluene, polyethylene ether polymers, polyphenyl oxide polymers and combinations thereof. Copolymers operative as writing layers include the above-recited polymers in addition to copolymers of the same including butadiene, acrylonitrile and vinyl chloride. It is appreciated that an inventive writing layer is formed through free radical, addition or radiation polymerization from precursor monomers and/or oligomers. The polymeric precursor to writing layer 102 is optionally loaded with a particulate 104 substantially free of visible light fluorophores of incident visible light so as to afford a white or colored appearance, the particulate not fluorescing in the visible spectrum under UV illumination so as to obscure invisible ink markings 106 on the writing layer under the same illumination conditions. Particulate operative herein include ground paper lacking optical brighteners, titania, alumina, calcium carbonate, metal chalcogenides including oxides and sulfides. The particulate loading is preferably such that the resulting film is opaque. Typical particulate loadings are from 10 to 70 total weight percent of the film. Factors relevant in determining particle loading amounts illustratively include particle size, polydispersity, anisotropy, density and the average polymer molecule weight after cure.

An inventive writing system is provided that includes an inventive dry erase article as detailed above in concert with a first writing implement including an ultraviolet light visualized ink that becomes visible upon irradiation with a wavelength of 420 nanometers or less. An ultraviolet light source is also provided having an emission with a principal wavelength between 370 and 420 nanometers. It is appreciated that multiple visible color emission ultraviolet ink writing implements are operative herein, alone or with visible ink writing implements. Preferably, the ultraviolet light visualized ink writing implement is a solvent-based pen.

As a result of the ultraviolet ink markings not being visible under ambient visible light sources and visible ink not being visible under ultraviolet irradiation, the effective marking surface of an inventive article is doubled relative to a conventional white dry erase board. Additionally, an inventive dry erase article offers a number of dramatic presentation effects such as the posing of a query in ink visualized under a visible light source and writing the answer to the query in an ink visualized under exposure to ultraviolet light such that with activation of an ultraviolet light the answer appears from hiding in plain view. Still another advantage of an inventive dry erase article is that presentation materials can be written in ink visualized under exposure to ultraviolet light before a meeting without the contents being revealed to participants until the speaker so elects.

Patents and publications mentioned in the specification are indicative of the levels of those skilled in the art to which the invention pertains. These patents and publications are incorporated herein by reference to the same extent as if each individual patent or publication was explicitly and individually incorporated herein by reference.

One skilled in the art will readily appreciate that the present invention is described herein with specific examples representative of preferred embodiments. Changes with respect to the present invention and other uses therefor will occur to those skilled in the art. These changes are encompassed within the spirit of the invention as defined by the scope of the appended claims.

1. A dry erase article comprising:
a transparent or translucent polymeric writing layer having a top surface that is impenetrable to an ink; and
an opaque substrate substantially free of visible light fluorophores underlying said writing layer.

2. The article of claim 1 wherein said substrate is a pastel or neon color.

3. The article of claim 1 wherein said writing layer is transparent.

4. The article of claim 1 wherein said substrate is flexible.

5. The article of claim 1 wherein said substrate is paint on a base rigid structure.

6. The article of claim 1 wherein said substrate is a polyacrylate.

7. The article of claim 1 further comprising a transparent or translucent adhesive layer intermediate between said writing layer and said substrate.

8. The article of claim 1 further comprising a backing adhesive.

9. The article of claim 1 further comprising an ultraviolet light source secured to the article with an orientation to expose the top surface to ultraviolet emission from said light source.

10. A writing system comprising:
a dry erase article comprising: a transparent or translucent polymeric writing layer having a top surface that is impenetrable to an ink, and an opaque substrate substantially free of visible light fluorophores underlying said writing layer;
a first writing implement comprising a first ink visualized under exposure to ultraviolet light having a wavelength of less than 420 nanometers; and
an ultraviolet light source having a principal emission wavelength of between 370 and 420 nanometers.

11. The writing system of claim 10 wherein said substrate is a pastel or neon color.

12. The writing system of claim 10 wherein said ultraviolet light source is an ultraviolet light emitting diode.

13. The writing system of claim 10 wherein said light source is secured to said article with an orientation so as to expose the top surface of said writing layer to the emission from said light source.

14. The writing system of claim 10 wherein said substrate is flexible.

15. The writing system of claim 10 wherein said substrate is paint on a base rigid structure.

16. The writing system of claim 10 wherein said substrate is a polyacrylate.

17. The writing system of claim 10 further comprising a second writing implement containing a second ink visualized under a visible light source selected from the group consisting of: sunlight, incandescent and fluorescent lights.

18. A process for forming dry erasable UV ink indicia comprising:
bonding a prepolymer composition that upon cure produces a polymeric writing surface impenetrable to ink with particulate substantially free of visible light fluorophores such that said writing surface is opaque;
applying said prepolymer composition to a structure allowing said prepolymer composition to cure; and
forming invisible ink markings on said writing surface.

19. The process of claim 18 wherein said writing surface has a pastel or neon color.

20. The process of claim 18 wherein said particulate is ground paper independent of optical brighteners.
